(19) United States
(12) Patent Application Publication
(10) Pub. No.: US 2012/0229001 A1
(43) Pub. Date: Sep. 13, 2012

(54) GENERATOR APPARATUS FOR A VEHICLE

(75) Inventor: Jong Hyun Kong, Masan (KR)

(73) Assignee: Urban Environment Engineering Co., Ltd., Gwangju (KR)

(21) Appl. No.: 13/509,080

(22) PCT Filed: Nov. 17, 2009
(86) PCT No.: PCT/KR09/06763

§ 371 Date: May 10, 2012

(51) Int. Cl. H02N 2/18

(52) U.S. Cl. 310/339

(57) ABSTRACT

The present invention relates to a generator apparatus for a vehicle, which uses the pressure exerted on the wheels of a vehicle while the vehicle travels to generate electricity to provide a source of driving power for a vehicle that is driven by electricity, such as an electric car or a hybrid vehicle. The generator apparatus is installed on a rotating wheel of a vehicle and comprises a generator module including a plurality of piezoelectric devices that generate electricity by means of pressure transferred from the ground through the wheel when the wheel rotates, a condenser for storing electricity generated by the generator module, and a connecting unit electrically connecting the generator module to the condenser. The generator module may include a supporting member installed on the wheel flange and covered by a tire, and the piezoelectric devices installed on the supporting member. The connecting unit includes a rotating disk installed on an axle supporting the wheel, and having contacting terminals extending in a circumferential direction on one side of the rotating disk, a power connection member, one side of which is electrically connected to the generator module and the other side of which is connected to the rotating disk; and a contact connector supported on the axle or on the frame of the vehicle, and having a brush contacting the two contacting terminals.

### BACKGROUND OF THE INVENTION

1. Field of the Invention

The present invention relates to a generator apparatus for a vehicle, generator apparatus for a vehicle, and more particularly, to a generator apparatus for a vehicle, which uses the pressure exerted on the wheels of a vehicle while the vehicle travels to generate electricity to provide a source of driving power for a vehicle that is driven by electricity, such as an electric car or a hybrid vehicle.

2. Description of the Related Art

In general, an automotive vehicle obtains its driving power by rotating wheels using the power generated while burning fossil fuels, such as gasoline or diesel. However, the conventional automotive vehicle is considered as one of major factors of environmental pollution due to greenhouse gases generated during combustion of fossil fuels, such as carbon dioxide, and other contaminants.

Therefore, in order to solve the problem, research into environmentally friendly vehicles, such as a solar vehicle, an electric car or a fuel cell vehicle, is actively conducted.

Among others, the electric car is vigorously researched and developed. However, since condensing technology of the electric car is unsatisfactory, there are still many problems to be commercialized due to a long charging time and a short discharging time. Therefore, development of a hybrid vehicle capable of reducing the amount of fossil fuels used by using both fossil fuels and electric energy is actively under way, and several types of hybrid vehicles are currently mass produced.

The currently mass produced hybrid vehicles often selectively use an electric motor or an internal combustion engine according to the vehicle's speed section. In general, wheels of vehicle are driven using an electric motor in a low speed section. However, when a traveling time of vehicle in the low speed section, like in a congested situation of the downtown area, is extended, it is difficult to obtain sufficient power to be supplied to the electric motor and the power is obtained from the internal combustion engine, instead. Thus, inefficient use of fuel and increased exhaustion of contaminant materials may be caused. In order to solve the problems, as a method of charging batteries during traveling of vehicle, independent electric power systems of electric cars is disclosed in Korean Patent Publication No. 2002-0008137.

The disclosed electric car includes a bevel gear device having bevel gears fixedly mounted on rear wheels of the car and configured to be rotated simultaneously with the rear vehicles by an axle guard, large rotating wheels rotated by the bevel gear device, and a high speed generator driven by the large rotating wheels and charging batteries.

In addition, Korean Patent Publication No. 2000-010126 discloses of a subsidiary charging device of an electric motor vehicle.

The disclosed electric motor vehicle includes a hopper for collecting the air flown in through a front part and both side parts of the motor vehicle, a fan for generating a rotary force satisfying for an air pressure of the wind induced through the hopper, a fan driving force managing unit for transmitting selectively the rotary force of the fan to the electric generator, a rotary number detecting sensor for detecting the number of revolutions of the fan as an electric signal, and a solar cell installed on the roof of the motor vehicle.

Since the disclosed electric motor vehicle generates electricity using the wind generated during traveling, air resistance applied to the vehicle is increased, so that battery charging effects may not be sufficient.

According to the above-described conventional technology, electricity generation using a pressure exerted on wheels of motor vehicle while the motor vehicle travels in contact with the ground.

### DISCLOSURE OF THE INVENTION

In order to overcome the above-mentioned shortcomings, the present invention provides a generator apparatus for a vehicle, which can promote stable supply of electricity used in driving an electric car or a hybrid vehicle by generating electricity using a pressure exerted on wheels of the electric car or the hybrid vehicle while the electric car or the hybrid vehicle travels.

According to an aspect of the invention, there is provided a generator apparatus for a vehicle, which is installed on a rotating wheel of a vehicle and includes a generator module including a plurality of piezoelectric devices that generate electricity by means of pressure transferred from the ground through the wheel when the wheel rotates, a condenser for storing electricity generated by the generator module, and a connecting unit electrically connecting the generator module to the condenser.

The generator module may include a supporting member installed on the wheel flange and covered by a tire, and the piezoelectric devices installed on the supporting member, and the connecting unit includes a rotating disk installed on an axle supporting the wheel, and having contacting terminals extending in a circumferential direction on one side of the rotating disk, a power connection member, one side of which is electrically connected to the generator module and the other side of which is connected to the rotating disk, and a contact connector supported on the axle or on the frame of the vehicle, and having a brush contacting the two contacting terminals.

The generator apparatus may further include a subsidiary generator unit generating electricity through a vibratory force of a vehicle, wherein the subsidiary generator unit includes a subsidiary generator module installed on the frame or the axle of the vehicle and having a plurality of piezoelectric devices, and a pressing member mounted in the vehicle to press the subsidiary generator module when the vehicle vibrates up and down. The pressing member may be formed of an elastic buffering member.

### ADVANTAGES AND EFFECTS OF THE INVENTION

Since the generator apparatus for a vehicle according to the present invention generates electricity using the pressure exerted as wheels of the vehicle rotate, charging of electricity to be used as the electricity of the electric car or the hybrid vehicle can be effectively assisted.

### BRIEF DESCRIPTION OF THE DRAWINGS

The objects, features and advantages of the present invention will be more apparent from the following detailed description in conjunction with the accompanying drawings, in which:

FIG. 1 is a partially extracted perspective view of a generator apparatus for a vehicle according to the present invention;

FIG. 2 is a cross-sectional view of the generator apparatus for a vehicle shown in FIG. 1; and

FIG. 3 is a block diagram of the generator apparatus for a vehicle shown in FIG. 2.

### DETAILED DESCRIPTION OF THE INVENTION

Hereinafter, a generator apparatus for a vehicle according to the present invention will be described in more detail.

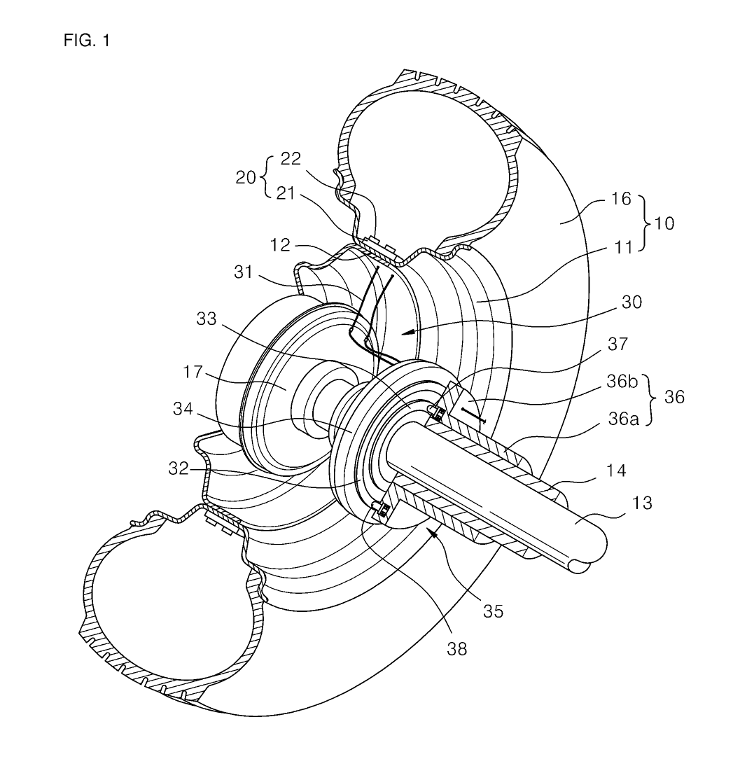

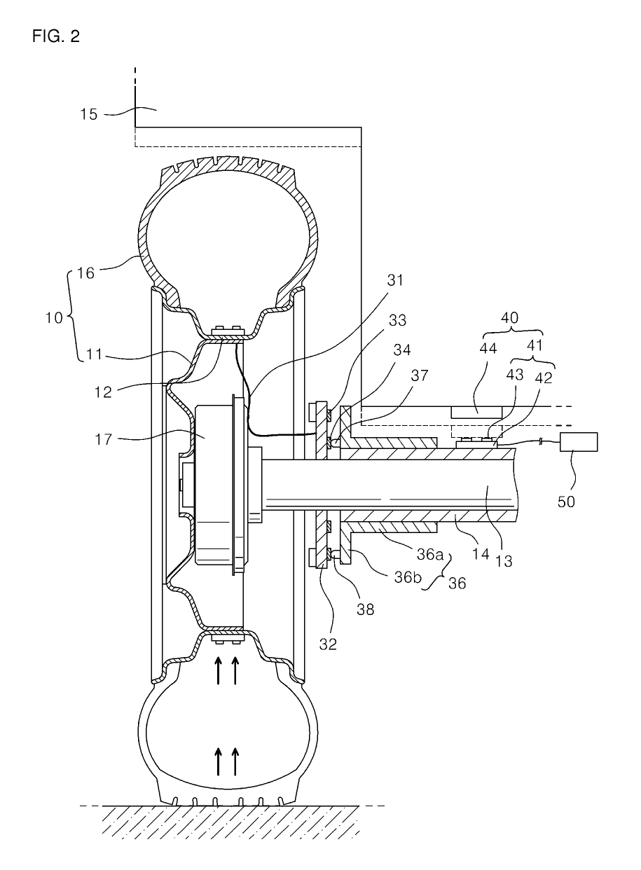

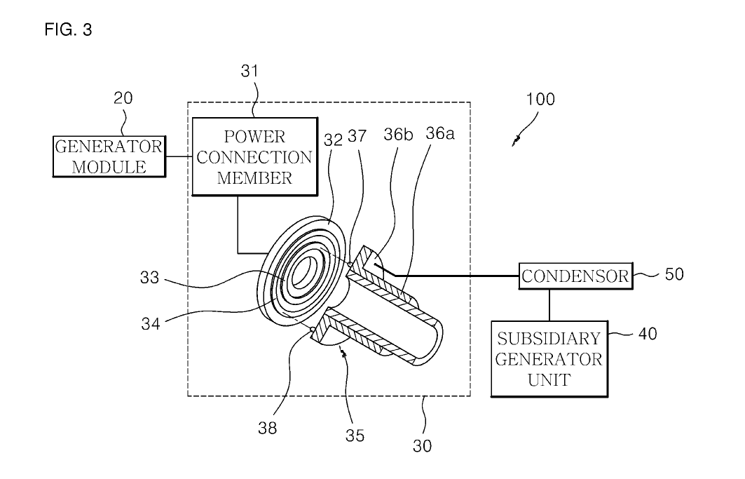

FIGS. 1 to 3 show an embodiment of a generator apparatus 100 for a vehicle according to the present invention.

Referring to FIGS. 1 to 3, the generator apparatus 100 includes a generator module 20 installed on a wheel 10, a subsidiary generator unit 40 generating electricity using a vibratory force of the vehicle, a condenser for storing electricity generated by the generator module 20, and a connecting unit electrically connecting the generator module 20 to the condenser.

The generator module 20 generates electricity using the pressure transferred from the ground through the wheel 10 when the wheel 10 rotates, and is mounted on a wheel flange 12 to be covered by the wheel 10.

The generator module 20 includes a support member 21 installed on a wheel drum 11, and a plurality of piezoelectric devices 22 installed on the support member 21.

The plurality of piezoelectric devices 22 generate electricity when the pressure or force is externally applied.

The wheel 10 performs a rolling motion while contacting the ground as the vehicle is driven, and the pressure is continuously transferred from the ground to the wheel 10. Therefore, the generator module 20 including the plurality of piezoelectric devices 22 to generate electricity using the pressure is installed in the wheel drum 11.

If the pressure is transferred from the ground when a tire 16 makes contact with the ground while the wheel 10 rotates, the plurality of piezoelectric devices 22 adjacent to the tire 16 in contact with the ground are subjected to the pressure derived from a pneumatic pressure, so that the plurality of piezoelectric devices 22 generate electricity using the pressure.

The support member 21 is configured such that the plurality of piezoelectric devices 22 are installed along the circumferential direction of the wheel drum 11. The support member 21 is preferably formed by a printed circuit board (PCB) having mounting holes to allow the plurality of piezoelectric devices 22 to be mounted thereon to electrically connect the plurality of piezoelectric devices 22 to each other.

The condenser stores the electricity generated from the generator module 20 or the subsidiary generator unit 40 to be described later, and may include a rechargeable secondary battery or a large capacity condenser. The electricity charged in the condenser may be used as the driving power of an electric car or a hybrid vehicle or a subsidiary power necessary for driving the electric car or the hybrid vehicle.

The connection unit connects the condenser and the generator module 20 to each other.

Since the wheel 10 having the generator module 20 installed therein rotates together with the wheel 10 as the vehicle is driven, a separate connection means 30 for connecting the electricity generated from the rotating generator module 20 to the condenser is required. The connection means 30 according to the present invention includes a power connection member 31 extending from the generator module 20, a rotating disk 32 installed in the vehicle axle 13 and a contact connector 35.

The power connection member 31 is an electric cable having one end electrically connected to the support member 21 so as to transfer the electricity generated from the plurality of piezoelectric devices 22, and the other end extending from the support member 21 while penetrating the wheel drum 11 and electrically connected to the rotating disk 32.

In order to prevent the wheel 10 from being ruptured due to interference of other components of a vehicle body 15 while rotating, the power connection member 31 has one side of its extending section fixed to a rotary drum 17, thereby making a length of the power connection member 31 substantially equal to a distance between the rotary drum 17 and the rotating disk 32.

The rotating disk 32 is shaped of a disk installed in the vehicle axle 13 and rotating with the vehicle axle 13. The rotating disk 32 includes first and second contact terminals 33 and 34 formed on one surface facing the wheel 10 and the other surface facing the one surface in a ring shape to be spaced a predetermined interval apart from the rotation center of the rotating disk 32.

The contact connector 35 includes a body 36 fixed to the axle guard 14 supporting the vehicle axle 13 and first and second brushes 37 and 38 installed in the body 36 and making contact with the first and second contact terminals 33 and 34, which are connected for transferring the power to the condenser in contact with the rotating disk 32.

The body 36 includes a cylindrical fixing member 36a installed in the axle guard 14, and an extending member 36b connected to one end of the fixing member 36a and having a larger outer diameter than the fixing member 36a.

Since it is necessary to configure the fixing member 36a and the extending member 36b so as to surround the axle guard 14, a hollow, through which the axle guard 14 penetrates, is provided to extend lengthwise at the center of the axle guard 14.

Although not shown, the fixing member 36a may be detachably fixed to the axle guard 14 by connection of a fixing bolt and a nut, and the extending member 36b may be formed to correspond to a diameter of the rotating disk 32 so as to allow the first and second brushes 37 and 38 to be installed on the surface exposed toward the rotating disk 32.

Since the rotating disk 32 rotates together with the vehicle axle 13 and the wheel 10, the first and second brushes 37 and 38 making contact with the first and second contact terminals 33 and 34 are electrically connected to allow the current to flow therein in contact with the first and second contact terminals 33 and 34 extending in a ring shape on the rotating disk 32. Since the first and second contact terminals 33 and 34 are shaped of rings differently spaced apart from the center of the rotating disk 32 in a radial direction, the first and second brushes 37 and 38 making contact with the first and second contact terminals 33 and 34, respectively, are spaced apart from the center of the extending member 36b by different distances, and are connected as a positive (+) pole and a negative (−) pole.

Since the rotating disk 32 makes contact with the first and second contact terminals 33 and 34 and the first and second brushes 37 and 38 while rotating, the contact may be released when the first and second contact terminals 33 and 34 and the first and second brushes 37 and 38 are abraded due to friction.

As shown in FIG. 1, an elastic member 39 pressing the first and second brushes 37 and 38 toward the rotating disk 32 is provided in the extending member 36b. Therefore, the contact between the first and second contact terminals 33 and 34 and the first and second brushes 37 and 38 can be maintained even if the first and second contact terminals 33 and 34 and the first and second brushes 37 and 38 are abraded due to friction.

The current generated from the generator module 20 is transferred to the condenser through the contact connector 35, thereby achieving charging.

The subsidiary generator unit 40 generates electricity using a vibratory force of the vehicle vibrating up and down while traveling, and includes a subsidiary generator module 41 installed in the vehicle axle 13, and a pressing member 44 installed in the vehicle body 15 and pressing the subsidiary generator module 41 due to up-and-down vibration of the vehicle.

The subsidiary generator module 41 includes a support member 42 installed in the vehicle axle 13 and a plurality of piezoelectric devices 43 supported to the support member 42. Since the plurality of piezoelectric devices 43 are installed so as to be pressed by the pressing member 44 installed in the vehicle body 15, the electricity is generated from the plurality of piezoelectric devices 43 using the pressure derived from the pressing member 44 when the vehicle body 15 is lowered.

The vibration of vehicle may not be severe in a normal traveling situation. However, when the vehicle travels on an uneven road, such as a speed bump, the vehicle may vibrate up and down. Therefore, electricity generation may be achieved using the vibratory force.

In order to prevent the plurality of piezoelectric devices 43 or the support member 42 in the course of pressing the subsidiary generator module 41, the pressing member 44 is preferably formed of an elastically deformable buffering member.

Since the subsidiary generator unit 40 is also electrically connected to the condenser, the electricity generated from the subsidiary generator module 41 is charged in the condenser, the electricity charged in the condenser may be used for traveling of the vehicle and supplying the power to electric devices of the vehicle.

While the present embodiment illustrates that the subsidiary generator module 41 is installed in the vehicle axle 13, the subsidiary generator module 41 may be installed on the frame of the vehicle. The pressing member 44 and the subsidiary generator module 41 may be oppositely installed in view of locations.

The generator apparatus 100 according to the present invention operates as follows.

When the vehicle starts to travel, the wheel 10 rotates as the vehicle axle 13 rotates.

The tire 16 contacting the ground when the wheel 10 rotates is subjected to the pressure transferred from the ground, and the pressure is transferred to the generator module 20 mounted in the wheel drum 11 through the air present within the tire 16. The plurality of piezoelectric devices 22 of the generator module 20 generate the electricity by the pressure transferred from the ground as the wheel 10 rotates, and the electricity generated from the generator module 20 is transferred to the rotating disk 32 through the power connection member 31, while the current is transferred to the condenser by contacts between the first and second contact terminals 33 and 34 of the rotating disk 32 and the first and second brushes 37 and 38 of the contact connector 35, thereby achieving charging.

In addition, subsidiary generator unit 40 generates the electricity using vibration of the vehicle when the vehicle travels on the speed bump or the uneven road. As the pressing member 44 installed in the vehicle body 15 vibrates up and down as the vehicle vibrates, it presses the plurality of piezoelectric devices 43 of the subsidiary generator module 41 installed in the vehicle axle 13, thereby generating the electricity.

The electricity generated from the subsidiary generator unit 40 is also charged in the condenser and can be used to drive the vehicle or to supply power to electric devices of the vehicle, if necessary.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

### INDUSTRIAL APPLICABILITY OF THE INVENTION

The generator apparatus for a vehicle according to the present invention can be installed on a car in a simplified manner and provides high industrial availability.

What is claimed is:

1. A generator apparatus for a vehicle, which is installed on a rotating wheel of a vehicle and comprises:
a generator module including a plurality of piezoelectric devices that generate electricity by means of pressure transferred from the ground through the wheel when the wheel rotates;
a condenser for storing electricity generated by the generator module; and
a connecting unit electrically connecting the generator module to the condenser.

2. The generator apparatus of claim 1, wherein the generator module includes a supporting member installed on the wheel flange and covered by a tire, and the piezoelectric devices installed on the supporting member, and the connecting unit includes a rotating disk installed on an axle supporting the wheel, and having contacting terminals extending in a circumferential direction on one side of the rotating disk, a power connection member, one side of which is electrically connected to the generator module and the other side of which is connected to the rotating disk, and a contact connector supported on the axle or on the frame of the vehicle, and having a brush contacting the two contacting terminals.

3. The generator apparatus of claim 1, further comprising a subsidiary generator unit generating electricity through a vibratory force of a vehicle, wherein the subsidiary generator unit includes a subsidiary generator module installed on the frame or the axle of the vehicle and having a plurality of piezoelectric devices, and a pressing member mounted in the vehicle to press the subsidiary generator module when the vehicle vibrates up and down.

4. The generator apparatus of claim 3, wherein the pressing member is formed of an elastic buffering member.
